(19) United States
(12) Patent Application Publication
(10) Pub. No.: US 2025/0290641 A1
(43) Pub. Date: Sep. 18, 2025

(54) COOKING APPARATUS, ACCESSORY FOR A COOKING APPARATUS AND METHOD

(71) Applicant: OONI LIMITED, Broxburn (GB)

(72) Inventors: Fraser Andrew HERD, Edinburgh (GB); Mike VAONA, Broxburn (GB); David KELLY, Edinburgh (GB)

(21) Appl. No.: 18/859,785

(22) PCT Filed: Apr. 28, 2023
(86) PCT No.: PCT/GB2023/051151

§ 371 Date: Oct. 24, 2024

(30) Foreign Application Priority Data
Apr. 29, 2022 (GB) 2206309.3

(51) Int. Cl. F24C 15/28; F24C 15/04

(52) U.S. Cl. CPC F24C 15/28; F24C 15/04

(57) ABSTRACT

An aspect of the invention provides a cover for an opening of a cooking chamber of an oven comprising a shield to cover an upper portion of the opening, the shield comprising a light-permeable viewing area, and the shield having a lower edge, the lower edge configured to define the top of a food-receiving aperture within the opening.

### FIELD OF THE INVENTION

The present invention relates to the field of cooking apparatus and accessories for cooking apparatus, and in particular, the cooking apparatus comprising an oven.

### BACKGROUND TO THE INVENTION

Wood-fired ovens are commonly used in commercial kitchens for the cooking of baked goods (including pizzas), meats, vegetables and other foodstuffs. In particular, such ovens provide the very high temperatures required to cook dough-based products adequately and to provide foodstuffs such as pizzas with a characteristically smoky or charred flavour. Before cooking any foodstuffs, the oven is preheated to the desired high temperature. It is desirable to retain the heated air within the oven when inserted and removing foodstuffs from the oven and during the cooking process.

Typically, such ovens include an opaque door to seal the cooking chamber of the oven to retain heat in the cooking chamber. When a user wishes to cook an item of food in the oven, they are required to keep the door closed to heat the oven to the desired temperature. When the user inserts food into the oven, they must first open the door to access the cooking chamber, place the food inside and then close the door. This is a time-consuming process during which heated air can escape from the cooking chamber after the cooking chamber has reached the desired temperature. Steam and smoke may also be released which is uncomfortable for a user. When a user removes food from the cooking chamber, the user must again open the door and can then insert a new item of food. In some cases, the user needs to open the door multiple times during the cooking of an item of food to check how cooked the food is.

Some embodiments of the present invention aim to provide an accessory for an oven to improve the retention of heated air, thereby improving fuel usage and cooking consistency. Some embodiments of the invention aim to provide an accessory for an oven to improve user convenience when inserting, cooking and removing foodstuffs from the oven. Some embodiments of the invention aim to improve the design and function of portable ovens.

### SUMMARY OF THE INVENTION

A first aspect of the invention provides a cover for an opening of a cooking chamber of an oven comprising a shield to cover an upper portion of the opening. The shield May comprise a light-permeable viewing area. Typically, the shield comprises a lower edge, the lower edge configured to define the top of a food-receiving aperture within the opening.

A second aspect of the invention provides an oven having a housing and cooking chamber with an opening and comprising the cover as described above, wherein the cover is attached to the housing thereby covering an upper portion of the opening and defining the top of a food-receiving aperture within the opening.

For the purpose of this application, the terms “upper” and “lower” are intended to refer to directions of the oven in normal use. The term “upper” corresponds to vertically higher position than the term “lower”. Similarly, the terms “right” and “left” are intended to refer to directions of the oven in normal use.

Accordingly, when the shield is fitted to the opening of a cooking chamber of an oven, the shield occludes the upper portion of the opening, thereby retaining heated air within the cooking chamber in use. As the upper portion of the cooking chamber will be hottest during use this can greatly reduce the loss of heated air through the opening. However, the food-receiving aperture enables a user to introduce or remove food which is to be cooked without a requirement to open a door or otherwise allow a large volume of heated air to escape from the cooking chamber. In addition, the user can view inside the cooking chamber through the viewing area to see how cooked the food is within the oven without the requirement to open a door.

Another problem faced by users of an oven with a conventional door is that there is a build-up of steam/smoke that is released from within the cooking chamber when the door is opened. This is inconvenient for the user because it can block the user's vision or potentially burn the user.

Typically, the shield may extend from the upper edge of the opening of the cooking chamber. The shield may extend vertically downwards from the upper edge of the opening of the cooking chamber to the lower edge of the shield. The upper and lower edges of the viewing area may fall between the upper edge of the opening and the lower edge of the shield. The shield may extend across the breadth of the opening, in that the shield extends from the right side of the opening to the left side of the opening. The viewing area may extend across a portion, or all, of the breadth of the shield.

The light-permeable viewing area may be a window. The light-permeable viewing area may be a viewing port. The light-permeable viewing area may be a viewing panel. The viewing area may be formed of a sheet of light-permeable material. The viewing area may allow a user to view the interior of the cooking chamber through the viewing area.

The base of the food-receiving aperture is typically aligned with a food-receiving base (for example a pizza stone) of the cooking chamber. That is, the lower edge of the food-receiving aperture may be level with the food-receiving base of the cooking chamber. This allows for smooth placement and removal of food from the cooking chamber because the food is easily transferred from a food holder (for example a pizza peel) to the cooking chamber.

It may be that the cover does not comprise a gripping member, such as a handle. This is advantageous because the absence of a gripping member discourages touching the cover when it is hot.

It may be that the oven is a pizza oven. A pizza oven is an oven configured for cooking one or more pizzas. It may be that the cooking chamber is configured for cooking one or more pizzas. It may be that the cooking chamber is dimensioned and sized for cooking one or more pizzas. A cooking chamber configured for cooking one or more pizzas typically has a (e.g. interior) length and/or a (e.g. interior) breadth greater than a (e.g. interior) vertical height of the cooking chamber.

The cooking chamber is typically internal to the oven, that is to say it is an internal cooking chamber.

The food-receiving aperture has a breadth greater than its vertical height to align with the dimensions of the cooking chamber. Typically the breadth to vertical height ratio is in the range of 10:1 to 2:1, preferably in the range 5:2 to 5:1. This dimension ratio is similar to the dimension ratio of a pizza which has a radius greater than its vertical height. Advantageously, this allows for foodstuffs with a breadth greater than its vertical height (for example a pizza) to be easily inserted into the cooking chamber but also for the shield to cover a considerable portion of the opening to the cooking chamber to reduce heat loss.

Typically, the height of the food-receiving aperture is at least 5% of the height of the cooking chamber. Optionally, the height of the food-receiving aperture may be at least 10% of the height of the cooking chamber. The height of the food-receiving aperture may be at least 20% of the height of the cooking chamber. The height of the food-receiving aperture may be no more than 20% of the height of the cooking chamber. Optionally the height of the food-receiving aperture may be no more than 30% of the height of the cooking chamber. The height of the food-receiving aperture may be no more than 50% of the height of the cooking chamber. Typically, the height of the food-receiving aperture may be no more 70% of the height of the cooking chamber. The height of the food receiving aperture may be between 10% and 50% or between 20% and 40% of the height of the cooking chamber. Typically, the height of the food-receiving aperture is at least 40% of the height from the food-receiving base to the top of the cooking chamber. Optionally, the height of the food-receiving aperture is at least 50% of the height from the food-receiving base to the top of the cooking chamber. Optionally, the height of the food-receiving aperture is at least 60% of the height from the food-receiving base to the top of the cooking chamber. Optionally, the height of the food-receiving aperture may be between 40% to 70% or 50% to 70% of the height from the food-receiving base to the top of the cooking chamber.

The height of the food-receiving aperture is typically at least 2 cm, at least 5 cm, or least 10 cm. The height of the food-receiving aperture may be less than 20 cm, less than 15 cm, less than 10 cm or even less than 5 cm. The height of the food-receiving aperture may be between 3 cm and 10 cm or between 5 cm and 12 cm or between 6 cm and 10 cm.

Advantageously, the above size ranges provide a good balance between providing a space to enable food, particularly a pizza to be put into or removed from the oven whilst also retaining heat within the cooking chamber.

It may be that the shield acts as at least a partial seal between the cooking chamber and a surrounding environment of the oven. The shield may act as a partial seal between the cooking chamber and a surrounding environment of the oven. The shield restricts the passage of heated air out of the cooking chamber during use. The cooking chamber may be entirely exposed without the cover such that heated air can escape through the entire opening of the cooking chamber. When the cover is attached to the oven, the shield may partially seal the opening of the cooking chamber, for example around the upper portion of the opening. The seal may be gas-tight, but this is not essential. As a result, heated air is unable to escape from the cooking chamber through the entire opening and any potential heat loss is restricted to being through the food-receiving aperture.

It may be that the shield comprises a frame extending beyond at least part of the periphery of the viewing area. The frame may extend vertically below the viewing area. The frame may follow the general shape of the opening of the cooking chamber. Advantageously, this may facilitate attachment of the cover to the housing and provide additional sealing to further reduce heat loss. It may be that the frame extends along a portion of the shield such that a boundary between the shield and the food-receiving aperture is defined by the frame. The shield may be attached to the oven via the frame being attached to the oven.

It may be that a first portion of the frame defines a lower edge of the food-receiving aperture. Thus the aperture may be defined between the lower edge of the shield and the first portion of the frame (typically an upper (or inner) edge of the first portion of the frame). The frame may extend to either side of the aperture. The aperture May therefore be defined by the shield and the frame.

It may be that a second portion of the frame forms the lower edge of the shield. Thus the food-receiving aperture may be defined between the second portion of the frame (typically a lower (or outer) edge of the second portion of the frame) being the lower edge of the shield and the first portion of the frame. The frame may extend to either side of the aperture. The aperture may therefore be defined by the frame at upper and lower boundaries, where the frame at the upper boundary of the aperture forms the lower edge of the shield.

Typically, the viewing area may be formed by a sheet of light permeable material. Optionally, the viewing area may be formed by a sheet of transparent material. The light-permeable material is visible light permeable. The viewing area may be formed by one or more sheets of transparent material. Optionally, the viewing area may be formed by one or more sheets of light permeable material. For example, the viewing area may be double glazed. The one or more sheets of transparent material may each be the same transparent material. Thus, a user is able to look through the viewing area to see inside the cooking chamber, which is particularly advantageous when food is cooking inside the cooking chamber. The user can see how cooked an item of food is without causing loss of heated air as would be the case if a traditional opaque door was used instead. The sheet of light permeable material is typically transparent.

It may be that the viewing area is formed by more than one material. That is, the viewing area may be formed by two or more overlapping materials. The two or more overlapping materials may entirely overlap or partially overlap. For example, the viewing area may be formed by a sheet (or one or more sheets) of light permeable material (i.e. transparent material) and a sheet of perforated steel. It will be appreciated that the viewing area may be formed of other materials to form a light permeable viewing area.

The oven may be required to reach high temperatures to cook food (e.g. at least 450° C.). Therefore, the light permeable material (or transparent material) should be able to withstand high temperatures without deforming or cracking. A material with a low thermal expansion coefficient would be useful for this purpose. Therefore, it May be that the viewing area is formed by borosilicate glass. That is, typically, the sheet of transparent material is formed by borosilicate glass.

It may be that the lower edge of the shield is formed by a lower edge of the viewing area to define the top of the food-receiving aperture. That is, the boundary between the food-receiving aperture and the shield may be defined by the lower edge of the viewing area. The sheet of light permeable material may extend to the lower edge of the shield. The cover comprising the lower edge of the shield formed by the lower edge of the viewing area may be easier to manufacture and require less material.

It may be that the shield is adjustable to alter the height of the lower edge of the shield, such that the height of the food-receiving aperture is adjustable. The shield may be adjustable along the vertical plane. Since the top of the food-receiving aperture is defined by the lower edge of the shield, moving the shield along the vertical plane adjusts the height of the food-receiving aperture as this raises or lowers the lower edge of the shield. It may be that the food-receiving aperture can be closed by adjusting the height of the lower edge of the shield. It is useful to close the food-receiving aperture when the cooking chamber is preheating to a desired temperature to reduce heat loss from the cooking chamber during the preheating.

The shield may be adjustable in multiple planes to adjust the height of the lower edge of the shield. It may be that the shield is adjustable along the horizontal plane. It may be that the shield is adjustable in the vertical and horizontal plane. It may be that the shield is adjustable by tilting the shield from the vertical (e.g. into the oven or away from the oven).

The height of the food-receiving aperture may be adjustable between a first height and a second height by moving the lower edge of the shield between a first shield position and a second shield position, respectively. The first height may correspond to a maximum height of the food-receiving aperture when the lower edge of the shield is in the first shield position. It may be useful to position the food-receiving aperture at the maximum height when it is desired to access the cooking chamber for maintenance and cleaning.

The second height may correspond to an appropriate height for use when the cooking chamber is used to cook food. The second height may be any height between the food-receiving aperture being closed and the first height. The second height may correspond to dimensions discussed above, such that the cooking chamber is accessible through the food-receiving aperture. Food can be placed into and removed from the oven without changing the height of the food-receiving aperture.

It may be that the height of the lower of edge of the shield is fixed. That is, the lower edge of the shield may not be adjustable, through adjustment of the shield itself or otherwise. The lower edge of the shield may be fixed at an optimum height for improving heat retention and allowing food to be inserted and removed. That is, the height of the lower edge of the shield may be set during manufacture as a permanent height. It may be that the position of the cover with respect to the oven is fixed whilst attached to the oven (e.g. the oven housing).

Advantageously, provision of a food-receiving aperture allows for quick loading and unloading of food into the cooking chamber whilst reducing heat loss and keeping the rate of heat loss consistent throughout the preheating and cooking phases to improve the consistency of the cooking phase.

Typically, the oven may comprise, in addition to the housing and the cooking chamber with the opening, a heated air source and a flue to regulate the flow of heated air within the cooking chamber. It may be that the interior of the cooking chamber is bounded (i.e. at least in part) by two or more opposing interior walls. For example, it may be that the interior of the cooking chamber is bounded by two or more opposing lateral interior walls. The two or more opposing lateral interior walls are typically substantially vertical walls. It may be that the cooking chamber is bounded by the two or more opposing lateral interior walls and a rear interior wall. The rear interior wall typically faces the opening of the cooking chamber. The two or more lateral interior walls typically extend between the rear interior wall and the opening end of the cooking chamber. It may be that the interior of the cooking chamber is bounded by a curved surface. For example, at least one of the lateral interior walls, and the rear interior wall may be curved such that there is no distinct border to define the at least one of the interior walls. The interior of the cooking chamber may be defined by a curved surface. It may be that the interior of the cooking chamber is defined by a single curved surface, such as a semi-circle. The cooking chamber may be bounded by the cover at the opening end of the cooking chamber.

Typically, the cover is removably attached to the oven housing. The cover may be removably attached using an attachment member, for example a latch or hinge. The attachment member may be configured to couple with the housing of the oven. The cover may not be intended for removal whilst the oven is in operation during the preheating phase or the cooking phase. However, it may be beneficial to remove the cover so that the cooking chamber is more accessible for cleaning or maintenance purposes.

It may be that the cover is operable as an oven door, the oven door having at least a first door position and a second door position. The oven door is typically moveable between a closed door position (i.e. the first door position) and an open door position (i.e. the second door position). In the closed door position, the (i.e. interior of the) cooking chamber is partially sealed from an external atmosphere (i.e. outside the oven). In the closed door position, the cover may extend across the breadth of the opening of the cooking chamber. In the closed door position, the cooking chamber may only be accessible through the food-receiving aperture.

In the open door position, the entire (i.e. interior of the) cooking chamber is fully externally accessible (i.e. from outside the oven). In the door open position, the cooking chamber may be fully accessible because the shield does not extend across the breadth of the opening of the cooking chamber in the open door position

The oven door may have a hinge attachment to the oven such that moving the oven door between the open and closed door positions comprises rotating the oven door about a hinge. The oven door may be releasably mountable within the food-receiving opening such that moving the oven door between the open and closed door positions comprises mounting and/or unmounting the oven door within the food-receiving opening.

It may be the cover is an oven door. It may be that the cover is moveable by rotation about a pivot.

In other examples, the shield may be part of the oven door.

In some examples, the shield is adjustable to alter the height of the lower edge of the shield independently of movement of the oven door. That is, when the cover is attached to an oven also having an oven door, the adjustment of the lower edge of the shield may be independent of movement of the oven door.

In some examples, the shield is adjustable to alter the height of the lower edge of the shield depending on movement of the oven door. That is, when the cover is attached to an oven also having an oven door, the adjustment of the lower edge of the shield may be dependent of movement of the oven door.

In the open door position, the oven door may be located below the base of the cooking chamber so that it does not obstruct access to the opening, under the cover.

Typically, in the open door position, the oven door is located below, or to the side of, the food receiving aperture so that food may be loaded into or removed from the cooking chamber, under the shield without contacting the door. Typically, in the open door position, the oven door does not intersect the plane of the base of the cooking chamber.

It may be that the frame of the cover is a door frame. For instance, when the cover is attached the oven and operable as the oven door, the frame may be a door frame. It is possible that the frame may include the attachment member to attach the cover to the oven.

It may be that the oven comprises an oven door and the cover is positioned behind the oven door. Some ovens may comprise both an oven door, such as an opaque oven door covering the entire opening of the cooking chamber, and the cover. The cover may be attached within the oven, behind the oven door such that the user has the option to cooking food with the oven door open with the cover in place. The cover May be permanently attached or demountably attached. Thus, the cover may reduce heat loss when the oven door is open whilst still allowing food to be introduced. The oven door may be open and closed whilst the cover is retained within the oven. The space between the cover and the oven door when closed may be between 1 cm and 50 cm, between 10 cm and 40 cm or between 20 cm to 30 cm.

It may be that the cover is positioned within the oven. That is, the cover may be attached in place within the oven (whether demountably or permanently attached). Typically, the cover may sit in a recess within the oven. The cover may be recessed within the oven by a distance of between 1 cm and 50 cm, between 10 cm and 40 cm or between 20 cm and 30 cm from the opening (or door, where present).

A third aspect of the invention provides an assembly for an oven comprising an oven door for an opening of a cooking chamber of the oven, the oven door comprising a light-permeable viewing area, and being moveable between an open position and a closed position. The assembly further comprises a shield having a lower edge, the shield being operably coupled to movement of the oven door and moveable between: a deployed configuration corresponding to the open position of the oven door; and a retracted configuration corresponding to the closed position of the oven door, wherein, in the deployed configuration, the shield is to cover the opening to a greater degree than when the shield is in the retracted configuration, and the lower edge of the shield is configured to define the top of a food-receiving aperture.

Advantageously, the use of a moveable oven door with a light permeable viewing area and a moveable shield provides the user of oven to which this assembly is attached with the ability to look inside the oven whilst also reducing heat loss. When the oven door is in the open position, the shield is deployed in the oven in the deployed configuration. As a result, the shield reduces heat loss from the oven when the oven door is open because it covers the opening to some extent. The lower edge of the shield may be spaced apart from a food-receiving base of the oven, such as a pizza stone, to form the food-receiving aperture. This allows a user to insert and/or remove food from the oven through the food-receiving aperture (i.e. the spacing between the shield and the food-receiving base) and through the opening of the cooking chamber, which is not covered by the oven door when the oven door is in the open position. When the oven door is in the closed position, the shield is retracted in the oven in the retracted configuration position. As a result, the view of the cooking chamber is less obscured by the shield in the retracted configuration than when the shield is in the deployed configuration. Since the oven door comprises a viewing area, the user is able to look through the viewing area of the oven door even when the oven door is in the closed position. The view of the cooking chamber is less obscured by the shield when the oven door is in the closed position than when the oven door is in the open position.

It may be that the lower edge of the shield is configured to define the top of the food-receiving aperture only when the shield is in the deployed configuration. It may be that the food-receiving aperture is defined partially by the lower edge of the shield at least when the shield is in the deployed configuration.

In some examples, the oven door may be separate to the shield.

The shield may be a structure positioned within the oven moveable between the deployed configuration and the retracted configuration. For example, the shield may be a piece of material operably coupled to the movement of the oven door. The shield may be a structure configured to retain heat within the oven. It may be that the shield retains heat by reducing the size of an opening through which heated air can escape the cooking chamber. It may be that the shield retains heat by directing heated air into the cooking chamber. For example, the shield may be a baffle configured to direct flow of heated air within the oven. The shield may be positioned within the oven and behind the oven door.

It may be that movement of the oven door between the open position and the closed position causes corresponding switching of the configuration of the shield between the deployed configuration and the retracted configuration, respectively. Typically, movement of the oven door from the open position to the closed position causes corresponding reversible deployment of the shield in the oven (i.e. the cooking chamber). It may be that movement of the oven door from the closed position to the open position causes corresponding reversal of deployment (that is, retraction) of the shield in the oven. It may be that the shield is removably mounted on the cover.

The oven door may completely close the opening of the cooking chamber. That is, when the oven door is in the closed position, the opening of the cooking chamber is completely covered such that there is no access provided to the interior of the cooking chamber.

The operable coupling between the shield and the oven door may be a mechanical coupling. It may be that the mechanical coupling is achieved using a coupling mechanism. The coupling mechanism mechanically couples the movement of the oven door with the movement of the shield, such that the shield and the oven door move in dependence on one another. The coupling mechanism may be a pivot or a latching mechanism. However, other coupling mechanisms will be envisaged. Alternatively, the oven door may be separate to the shield, such that the shield and the oven door move independently from one another.

It may be that the lower edge of the shield is positioned at a different position (e.g. a lower height) when the oven door is in the open position than the lower edge of the shield when the oven door is in the closed position. Therefore, it may be that movement of the shield between the deployed configuration and the retracted configuration comprises vertical displacement of the shield within the oven (or within the cooking chamber). The provision of the food-receiving aperture allows a user to insert and/or remove food from the oven when the shield is in the deployed configuration to retain heated air within the oven (i.e. the cooking chamber).

A fourth aspect of the invention provides an oven having a housing and cooking chamber with an opening and comprising the shield of the assembly attached to the oven thereby covering an upper portion of the opening in the deployed configuration, and the oven door of the assembly attached to the housing.

The oven for which the assembly is provided may be any oven as described above. The oven may comprise at least one of: a food-receiving base, a heated air source and a flue to regulate the flow of heated air within the cooking chamber.

The oven door of the fourth aspect may have a hinge attachment to the oven such that moving the oven door between the open and closed positions comprises rotating the oven door about a hinge. The oven door of the fourth aspect may be releasably mountable within the opening such that moving the oven door between the open and closed positions comprises mounting and/or unmounting the oven door within the opening.

A fifth aspect of the invention provides a method of using an oven as described above, the method comprising inserting food into or removing food from the cooking chamber through the food-receiving aperture. The method may comprise inserting food into or removing food from the cooking chamber through the food-receiving aperture while the cover is attached to the oven. The method may comprise inserting food into or removing food from the cooking chamber through the food-receiving aperture while the shield of the assembly is attached to the oven. It may be that the method comprises inserting food into or removing food from the cooking chamber through the food-receiving aperture while the oven door of the assembly is attached to the oven. The food may be inserted into and/or removed from the cooking chamber using a food holder, such as a pizza peel.

The food may be inserted and/or removed from the cooking chamber while the oven is in use, for example, while temperature of gas in the cooking chamber exceeds 400° C. The gas in the cooking chamber may comprise steam and/or smoke. The shield resists the flow of gas from the cooking chamber out of the opening.

Typically, the method may comprise viewing a pizza in the cooking chamber through the light-permeable viewing area, typically while it is being cooked. In this way, the user is able to see how cooked a food item is without causing additional heat loss. The method may comprise viewing a pizza in the cooking chamber through the light-permeable viewing area of the shield of the cover. The method may comprise viewing a pizza in the cooking chamber through the light-permeable viewing area of the oven door of the assembly for the oven.

It may be that the method comprises adjusting the height of the lower edge of the shield. The height of the lower edge of the shield may be adjusted in dependence on the phase of the oven, for example the oven may be in a preheating (i.e. initial heating phase), or a cooking phase in which food is being cooked in the oven. It may be that the method comprises adjusting the height of the lower edge of the shield of the cover or it may be that the method comprises adjusting the height of the lower edge of the shield of the assembly for the oven.

It may be that the method comprises lowering the lower edge of the shield during an initial heating phase or a cooking phase of the oven. It may be that the method comprises lowering the lower edge of the shield of the cover during an initial heating phase or a cooking phase of the oven. It may be that the method comprises lowering the lower edge of the shield of the assembly for the oven during an initial heating phase or a cooking phase of the oven.

It may be that the method comprises raising the lower edge of the shield during operation of the oven to insert food in and/or remove food from the cooking chamber. It may be that the method comprises lowering the lower edge of the shield, typically for cleaning purposes once food has been removed from the cooking chamber and the cooking chamber has cooled down. It may be that the method comprises raising the lower edge of the shield of the cover during operation of the oven to insert food in and/or remove food from the cooking chamber. It may be that the method comprises raising the lower edge of the shield of the assembly for the oven during operation of the oven to insert food in and/or remove food from the cooking chamber.

It may be that the method comprises opening the cover when the cover is operable as an oven door. The method may comprise opening to cover to the second door position. Typically, the cover is attached to the oven as an oven door and is opened to the open door position (i.e. the second door position). It may be that the method comprises opening the oven door of the assembly for the oven.

It may be that the method comprises closing the cover when the cover is operable as an oven door. The method may comprise closing to cover to the first door position. Typically, the cover is attached to the oven as an oven door and is closed to the closed door position (i.e. the first door position). It may be that the method comprises closing the oven door of the assembly for the oven.

The method may comprise providing an oven having a door, removing the door and fitting a cover according to the first aspect to obtain an oven according to the second aspect.

It may be that the oven is (i.e. configured as) a portable oven. For example, the oven may be smaller and/or lighter than a conventional oven such that the oven may be moved easily by a user. It may be that the oven is provided with legs, feet, castors, rollers, wheels and/or an oven stand such that the oven may be safely positioned on the floor or on the ground outside during use. It may be that a (i.e. external) housing of the oven is (i.e. thermally) insulated such that a user may safely handle one or more external portions of the oven during use.

It may be that the heated air source comprises a fuel burner. The fuel burner may be configured to burn one or more of the following combustible fuels: wood chips, wood pellets, coal, split wood, twigs, gas, oil. Alternatively, the heated air source may be an electrical heated air source comprising an electric heating element.

Optional and preferred features of any one aspect of the invention may be features of any other aspect of the invention.

### DESCRIPTION OF THE DRAWINGS

An example embodiment of the present invention will now be illustrated with reference to the following Figures in which:

FIG. 1 is a view of the front of a cover;

FIG. 2 is a perspective view of an oven;

FIG. 3 is a different perspective view of the cover of FIG. 1 attached to the oven of FIG. 2;

FIG. 4 is a different perspective view of the cover of FIG. 1 attached to the oven of FIG. 2;

FIG. 5 is a view of the front of a cover;

FIG. 6 is a view of the front of a cover;

FIG. 7 is a view of the front of a cover;

FIG. 8 is a view of the front of a cover;

FIG. 9 is a view of the cover of FIG. 8 attached to an oven;

FIG. 10 is a different perspective of the cover of FIG. 1 attached to the oven of FIG. 2;

FIG. 11 is a cross-section of a cover within in an oven;

FIG. 12 is a cross-section of a cover within an oven;

FIG. 13 is a cross-section of a cover attached to an oven;

FIG. 14 is a cross-section of a cover attached to an oven; and

FIG. 15 is a cross-section of a cover attached to an oven.

### DETAILED DESCRIPTION OF AN EXAMPLE EMBODIMENT

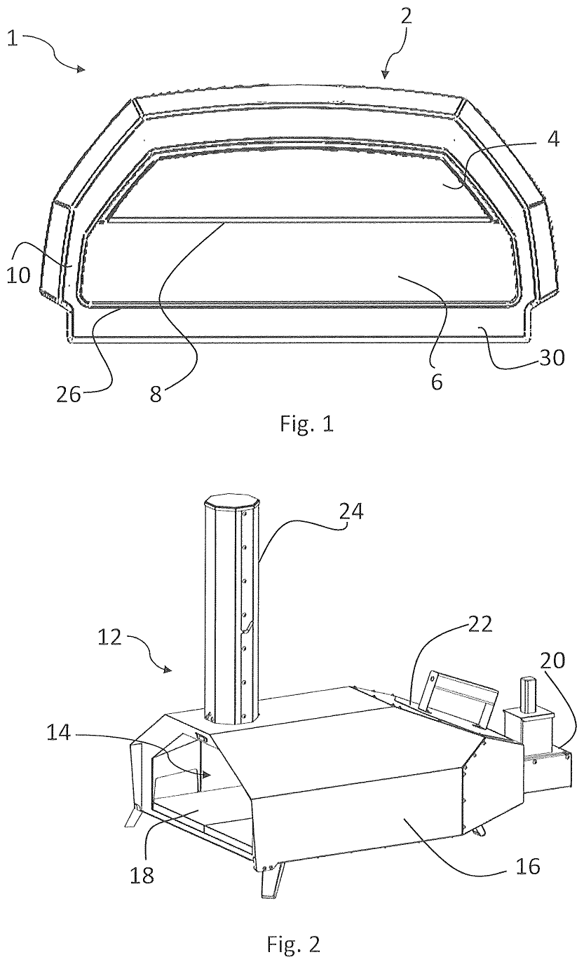

As shown in FIGS. 1, 3, 4, 5, 6, 7, 8, 9 and 10, a cover 1 for an opening of a cooking chamber of an oven comprises a shield 2 to cover an upper portion of the opening. The shield 2 comprises a light-permeable viewing area 4. The shield 2 has a lower edge 8, the lower edge defines the top of a food-receiving aperture 6 within the opening.

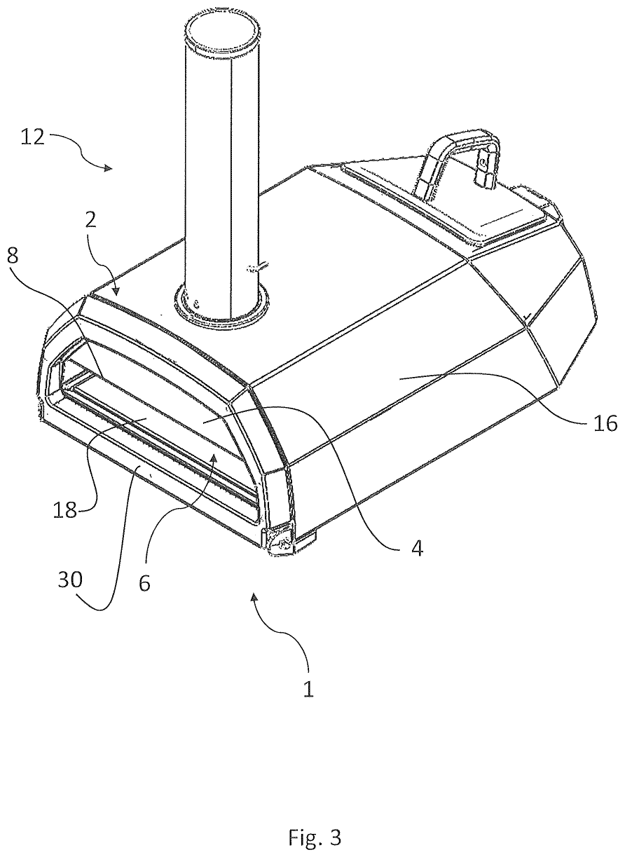

As shown in FIGS. 2, 3 and 4, an oven 12 comprises a cooking chamber 14 with an opening and a housing 16. The housing 16 may be supported on top of legs which extend from a base of the housing. A flue 24 may extend from a top surface of the body at a front end. An integrated or removable burner 20 may extend from a rear wall of the housing at a rear end. It is noted that the hatch lid 22 may be provided in the top surface of the housing at the rear end. The fuel hatch lid is for the purpose of adding fuel to the oven and is not intended for, nor appropriate for adding or removing food from the oven.

A food-receiving base 18, such as pizza stone, is provided within the housing 16, extending from the front end approximately three quarters of the way towards the rear end of the oven where the burner 20 is mounted. The interior of the burner 20 is in gaseous communication with the interior of the housing 16 such that, in use, heated air and combustion products can flow from the burner 20 into the housing 16.

In FIG. 3, the cover 1 is attached the housing 16 of the oven 12 thereby covering an upper portion of the opening and defining the top of the food-receiving aperture 6 within the opening. When the cover 1 is attached to an oven 12, the shield 2 may partially seal the cooking chamber 14 from the external atmosphere. Heated air is unable to escape through the entire opening of the cooking chamber and may instead only escape through the smaller space of the food-receiving aperture 6.

The light-permeable viewing area 4 is formed by a sheet of light permeable material, which may be borosilicate glass, to allow the user to see through the viewing area 4 into the cooking chamber 14.

As shown in FIG. 1, the shield 2 comprises a frame 10 which extends beyond at least part of the periphery of the viewing area 4 in that it extends vertically below the viewing area 4. In FIG. 3, it shown that the shape of the frame 10 corresponds to the shape of the opening of the cooking chamber 16. A first portion 30 of the frame may define a lower edge 26 of the food-receiving aperture 6. As shown in FIG. 3, the first portion 30 of the frame may align with a food-receiving base 18, such as a pizza stone to provide a smooth transition of food into and out of the cooking chamber 14.

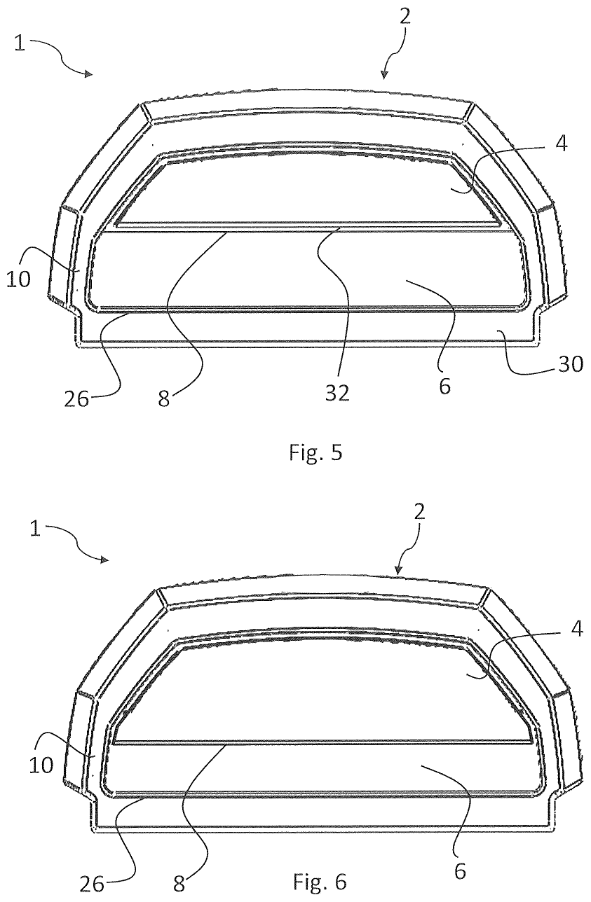

As shown in FIG. 5, the frame 10 may at least partially enclose the viewing area 4. A second portion 32 of the frame forms the lower edge 8 of the shield. In this way, the top of the food-receiving aperture 6 is defined by the second portion 32 of the frame.

As shown in FIG. 1, the lower edge 8 of the shield 2 may be formed by the viewing area 4. The lower edge of the viewing area 4 may be the lower edge 8 of the shield. In this way, the upper edge of the food-receiving aperture 6 is defined by the lower edge of the viewing area 4.

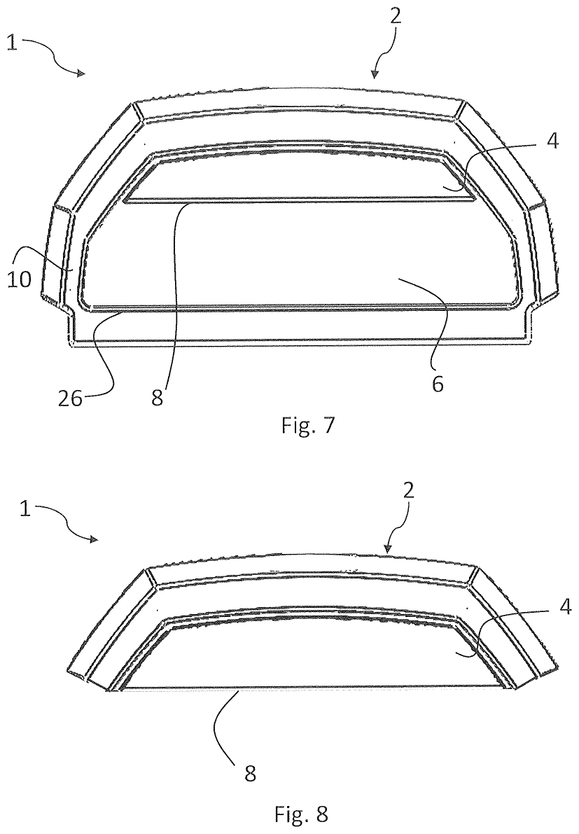

The shield 2 may be adjustable to alter the height of the lower edge 8 of the shield, such that the height of the food-receiving aperture is adjustable. Alternatively, the height of the lower edge 8 of the shield may be fixed. FIG. 1 shows one possible height of the lower edge 8 of the shield. FIG. 6 shows another possible height of the lower edge 8 of the shield which is lower than the height shown in FIG. 1. The lower the position of the lower edge 8 of the shield, the shorter the height of the food-receiving aperture 6. FIG. 7 shows another possible height of the lower edge 8 of the shield which is higher than the height shown in FIGS. 1 and 6. The higher the position of the lower edge 8 of the shield, the taller the height of the food-receiving aperture 6.

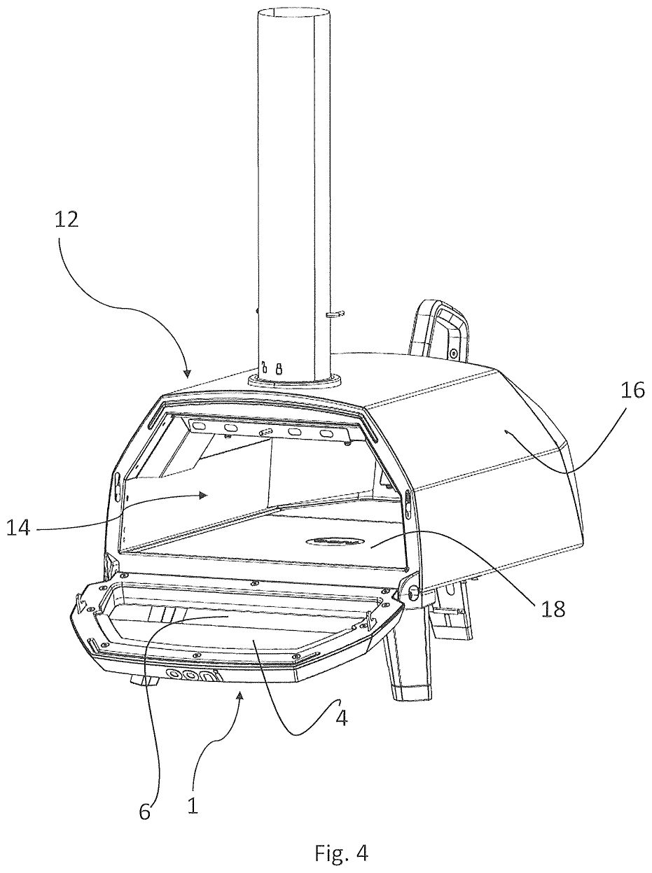

The cover 1 may be removably attached to the housing 16. The cover 1 is attached to the housing 16 using hinges in FIGS. 3 and 4. However, other attachment mechanisms will be envisaged, for example a latch mechanism. In FIGS. 3 and 4, the hinges are located at a lower edge of the housing 6. However, the attachment member may be located at the upper edge of the housing, a left side of the housing or a right side of the housing.

In an alternative embodiment, the cover 1 is permanently attached to the oven. In this embodiment, the viewing area 4 is a permanent feature of the oven such that is not possible to remove the viewing area 4. When the cover 1 is permanently attached to the oven, the interior of the cooking chamber 14 is only accessible through the food-receiving aperture 6. For example, the cover 1 may be permanently attached to housing 16 during manufacture or may be formed of a unitary component with the housing such that it is unable to be removed by the user.

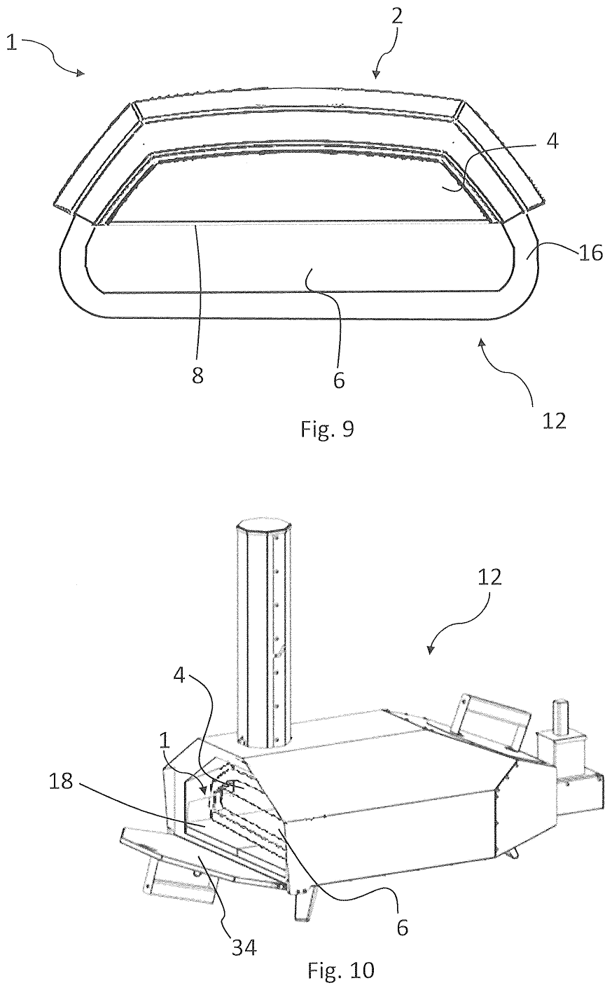

FIG. 8 shows an alternative cover 1 for the opening of the cooking chamber 14. This cover does not have a frame and is made up of the shield 2 and the viewing area 4. The lower edge 8 of the shield is formed by the lower edge of the viewing area. FIG. 9 shows the cover of FIG. 8 attached to the oven 12. The lower edge of the food-receiving aperture 6 is defined by the lower edge of the opening to the cooking chamber 14. For example, as shown in FIG. 9, the food-receiving aperture 6 is defined by the lower edge of the housing 16 (i.e. the lower edge of the opening) and the lower edge 8 of the shield.

FIG. 10 shows the cover 1 attached to the oven 12. The oven has an openable oven door 34. The cover 1 sits behind the oven door 34 and is recessed within the oven. A user can open the oven door 34 to access the food-receiving aperture 6 of the cover 1 to insert food onto the food-receiving base 18 of the cooking chamber 14. It will be appreciated that the distance between the oven door 34 and the cover 1 may differ from that show in FIG. 10. For example, the oven door 34 and the cover 1 may be positioned such that they abut one another when the oven door 34 is closed. In other embodiments, the cover 1 may be attached to the oven 12 and be recessed within the oven even when the oven 12 does not have the oven door 34.

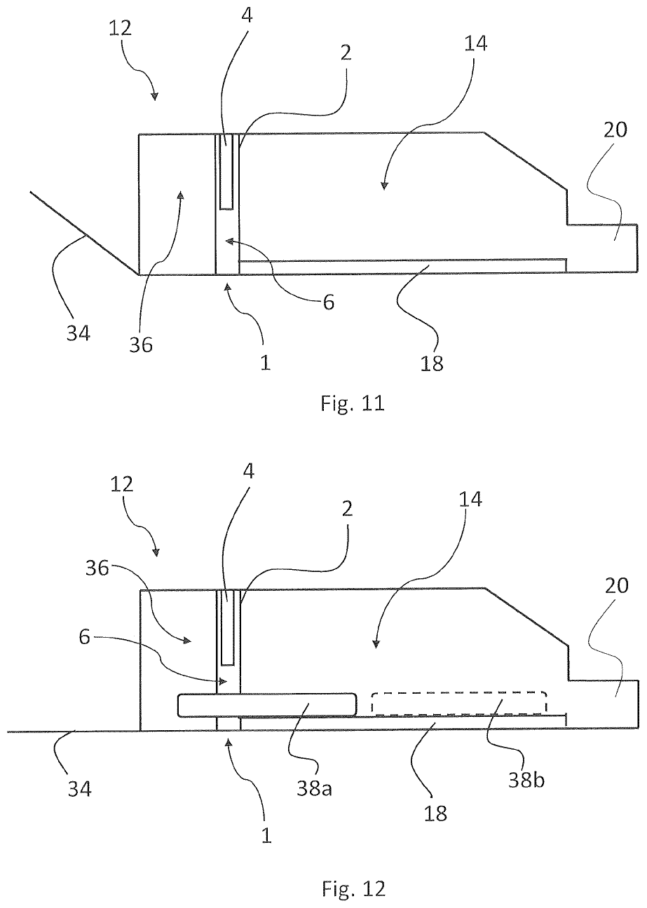

FIGS. 11 and 12 show a cross-section of the cover 1 positioned within the oven 12. When the cover 1 is placed within the oven 12, the cover 1 may partition the interior of the oven into a loading region 36 and the cooking chamber 14. FIG. 12 shows the process of introducing an item of food into the cooking chamber 14 when the cover 1 is positioned within the oven 12. An item of food is introduced into the cooking chamber 14 by passing through the food-receiving aperture 6, underneath the viewing area 4, as showing in position 38a. When the item of food is cooking, it sits entirely within the cooking chamber 14 on the food-receiving base 18, as shown in position 38b. The loading region 36 may be in thermal equilibrium with the cooking chamber 14 or May be at a lower temperature than the cooking chamber 14.

FIGS. 3 and 4 show the cover 1 being operable as an oven door. FIG. 3 shows the cover as the open door in an open position (i.e. a second door position). FIG. 4 shows the cover as the open door in a closed position (i.e. a first door position). In both FIGS. 3 and 4, the frame 10 is a door frame with the attachment member, such as the hinges, mounted to the frame 10.

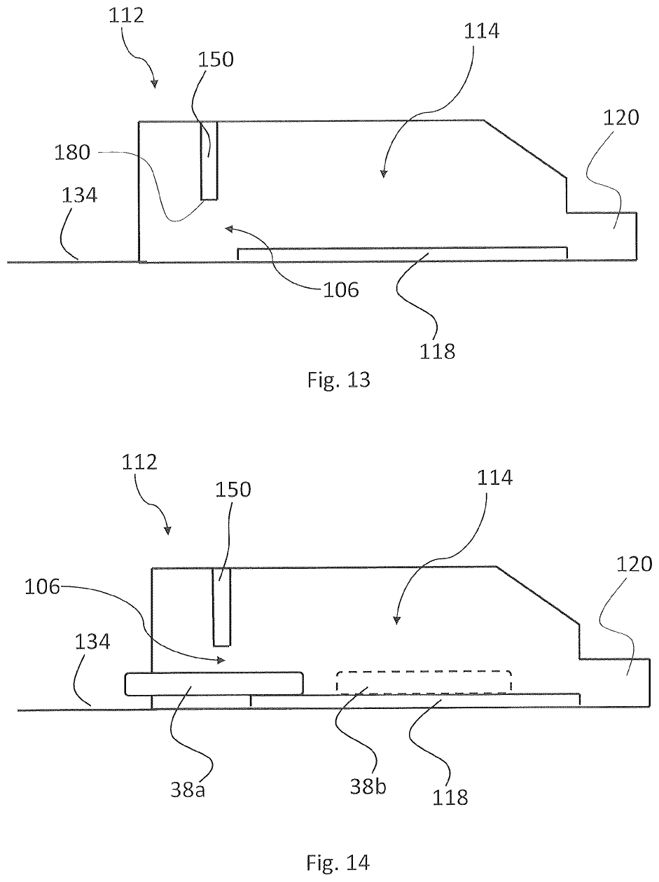

FIGS. 13 to 15 illustrate an assembly for an oven. The oven 112 comprises a cooking chamber 114, a heat source 120 in the form of a burner 120, a food-receiving base 118 and an oven door 134. The oven door 134 is operable as a door in that is moveable between an open position and a closed position. The oven 112 also comprises a shield 150 which is operably coupled to the oven door 134. When the oven door 134 is open, the shield 150 is configured in the deployed configuration as shown in FIGS. 13 and 14. The lower edge 180 of the shield in the deployed configuration is such that it is vertically spaced apart from the food-receiving base 118 to form a food-receiving aperture 106. As shown in position 38a and position 38b in FIG. 14, an item of food, e.g. a pizza can be inserted and/or removed from the oven 112 through the food-receiving aperture 106. As described hereinbefore, it will be understood that the shield 150 in the deployed configuration reduces heat loss from the oven 112 when the oven door 134 is open.

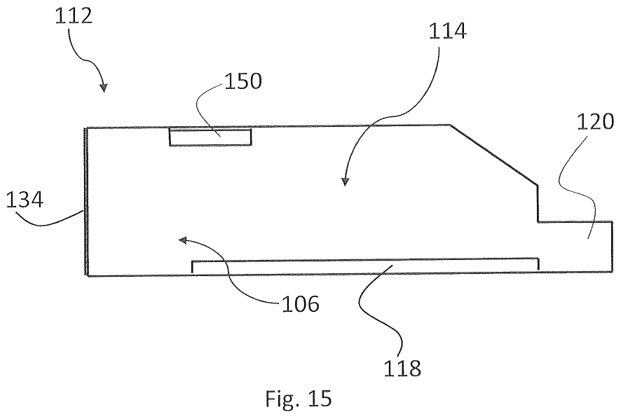

FIG. 15 shows the oven door 134 in the closed position. Since the oven door 134 and the shield 150 are operably coupled, the shield 150 is in the retracted configuration when the oven door 134 is closed. As a result, the vertical displacement of the shield 150 in the retracted configuration is such that the space between the food-receiving base 118 and the shield 150 is larger than the space between the food-receiving base 118 and the lower edge 180 of the shield 150 in the deployed configuration. Since the oven door 134 has a viewing area (not shown in FIGS. 13 to 15), the user of the oven 112 has a less obstructed viewing of the interior of the oven when the shield 150 is in the retracted configuration (i.e. when the oven door 134 is closed) than when the shield is in the deployed configuration (i.e. when the oven door 134 is open). Since the oven door 134 has a viewing area through which the interior of the cooking chamber can be seen and the shield 150 is in the retracted configuration when the oven door 134 is closed, the shield 150 may be formed of opaque material.

The open position is shown as the door being rotated 90 degrees from the closed position. However, it will be appreciated that this is embodiment is not limiting and that the open position of the oven door may be any position that is not the closed position and provides enough space for a user to insert and/or remove food from the oven.

In addition, the shield 150 is depicted as being generally rectangular in shape. However, other shapes of the shield 150 will be envisaged. For example, when the shield 150 is a baffle, the shield may have a different shape to that depicted in FIGS. 13 to 15.

The cover shown in the Figures comprises a frame and a light-permeable viewing area. However, in some embodiments, the cover may be formed entirely of light-permeable material. That is, the shield covering the upper portion of the opening may be formed entirely of light-permeable material, such that the entire shield forms the light-permeable viewing area. The light-permeable material may act as both a heat shield to reduce heat loss by covering the upper portion of the opening and as the viewing area. When the shield is formed entirely of light-permeable material, the lower edge of the light-permeable material may define the top of the food-receiving aperture within the opening.

While the oven 12 may be an oven for cooking pizzas (i.e. the size and shape of the cooking chamber is configured for cooking one or more pizzas), the oven may alternatively be configured for cooking other foodstuffs, including baked goods, roasted vegetables, casseroles, meat and fish, among others.

The food-receiving base 18 may be made of any suitable material, including aluminium, cast iron, stainless steel, stone (such as cordierite) or a ceramic material.

The housing 16 may be provided on legs, feet, castors, wheels or any other form of support. Alternatively, the oven body may rest directly on a (thermally insulating) work surface. The use of three legs in particular typically results in increased stability of the oven.

Further modifications and variations may be made within the scope of the invention herein disclosed.

1. A cover for an opening of a cooking chamber of an oven comprising:
a shield to cover an upper portion of the opening,
the shield comprising a light-permeable viewing area, and
the shield having a lower edge, the lower edge configured to define the top of a food-receiving aperture within the opening.

2. An assembly for an oven comprising:
an oven door for an opening of a cooking chamber of the oven, the oven door comprising a light-permeable viewing area, and being moveable between an open position and a closed position, and
a shield having a lower edge, the shield being operably coupled to movement of the oven door and moveable between:
a deployed configuration corresponding to the open position of the oven door; and
a retracted configuration corresponding to the closed position of the oven door,
wherein, in the deployed configuration, the shield is to cover the opening to a greater degree than when the shield is in the retracted configuration, and the lower edge of the shield is configured to define the top of a food-receiving aperture.

3. The assembly according to claim 2, wherein movement of the oven door between the open position and the closed position causes corresponding switching of the configuration of the shield between the deployed configuration and the retracted configuration, respectively.

4. The cover of claim 1, wherein the shield acts as a partial seal between the cooking chamber and a surrounding environment of the oven.

5. The cover of claim 1, wherein the shield comprises a frame extending beyond at least part of the periphery of the viewing area.

6. The cover of claim 5, wherein a first portion of the frame defines a lower edge of the food-receiving aperture.

7. The cover of claim 5, wherein a second portion of the frame forms the lower edge of the shield.

8. The cover of claim 5, wherein the shield is attachable to the oven via the frame being attached to the oven.

9. The cover or the assembly of claim 1, wherein the viewing area is formed by a sheet of transparent material, and optionally, wherein the sheet of transparent material is formed by borosilicate glass.

10. The cover of claim 1, wherein the lower edge of the shield is formed by a lower edge of the viewing area to define the top of the food-receiving aperture.

11. The cover or the assembly of claim 1, wherein the shield is adjustable to alter the height of the lower edge of the shield, such that the height of the food-receiving aperture is adjustable.

12. The cover or the assembly of claim 1, wherein the cover is an oven door moveable by rotation about a pivot.

13. An oven having a housing and cooking chamber with an opening and comprising the cover according to claim 1, wherein either:
the cover is attached to the housing thereby covering an upper portion of the opening and defining the top of a food-receiving aperture within the opening; or
the shield of the assembly is attached to the oven thereby covering an upper portion of the opening in the deployed configuration, and the oven door of the assembly is attached to the housing.

14. The oven of claim 13, wherein the cover is removably attached to the oven housing.

15. The oven of claim 13, wherein the cover is operable as an oven door, the oven door having at least a first door position and a second door position.

16. The oven of claim 13, wherein the shield comprises a frame extending beyond at least part of the periphery of the viewing area and wherein the frame of the cover is a door frame.

17. The oven of claim 13, comprising an oven door and wherein the cover is positioned behind the oven door, optionally wherein the cover is positioned within the oven.

18. A method of using an oven according to claim 13 comprising inserting food into or removing food from the cooking chamber through the food-receiving aperture.

19. (canceled)

20. The method of claim 18, comprising lowering the lower edge of the shield during an initial heating phase or a cooking phase of the oven.

21. The method of claim 18, comprising raising the lower edge of the shield during operation of the oven to insert food in and/or remove food from the cooking chamber.

22.-23. (canceled)
